(19) United States
(12) Patent Application Publication
(10) Pub. No.: US 2026/0344723 A1
(43) Pub. Date: Nov. 5, 2026

(54) PREPARATION AND COMPOSITIONS COMPRISING SACCHARIDES AND AMINO ACIDS, AND USE THEREOF

(71) Applicant: DSM IP Assets B.V., Maastricht (NL)

(72) Inventors: Elkin AMAYA, Kaiseraugst (CH); Estel CANET-MARTINEZ, Kaiseraugst (CH); Ivan de Jesus GAYTAN PEREZ, Kaiseraugst (CH); Nicholas HAGEMANN, Kaiseraugst (CH); Raphael MEYER, Kaiseraugst (CH)

(21) Appl. No.: 19/123,315

(22) PCT Filed: Oct. 25, 2023
(86) PCT No.: PCT/EP2023/079769

§ 371 Date: Apr. 22, 2025

(30) Foreign Application Priority Data
Oct. 26, 2022 (EP) 22203722.8
Oct. 16, 2023 (EP) 23203857.0

(51) Int. Cl. A23L 29/00; A23K 20/142; A23K 20/163; A23L 21/25; A23L 29/30

(52) U.S. Cl. CPC A23L 29/045; A23K 20/142; A23K 20/163; A23L 21/25; A23L 29/30

(57) ABSTRACT

The present invention relates to means and methods for reducing the viscosity of a (liquid) composition. The method comprises admixing to a composition comprising a saccharide a viscosity-reducing amount of an amino acid, thereby reducing the viscosity of said composition. Also disclosed are uses of an amino acid for reducing the viscosity of a (liquid) composition comprising a saccharide. A composition, an animal feed, a human food and a kit comprising a saccharide a viscosity-reducing amount of an amino acid are disclosed as well. Methods and uses for feeding an animal with the composition, animal feed or kit are also disclosed. Similarly, methods and uses for providing a human with composition, human food or kit are also disclosed.

### TECHNICAL FIELD

The present invention pertains to the field of animal feed, human food, animal feed additives or food and beverage additives. The present invention relates to means and methods for reducing the viscosity of a (liquid) composition. More particularly, the present invention relates to a composition comprising a saccharide and a viscosity-reducing amount of an amino acid, a method for reducing the viscosity of said composition, use of an amino acid for the same purpose, animal feed or human food comprising said composition, a kit comprising said composition, a method for providing an animal including humans comprising: providing said composition, animal feed including human food or kit, as well as uses thereof.

### BACKGROUND

Saccharide preparations, which may generally include monosaccharides, oligosaccharides, polysaccharides, functionalized oligosaccharides, or their combinations, are used as additives in nutritional compositions such as animal feed. It is noted that saccharide preparations are, e.g. described in WO2020/097458, which are hereby incorporated by reference. The purpose of providing oligosaccharides in animal feed lies, e.g. in their prebiotic properties, which have beneficial effects on animal performance, e.g., improved body weight and production performance through facilitating the beneficial bacterial colonies in the gastrointestinal tract. They are also of interest in the area of human nutrition, especially in beverage compositions.

However, saccharide preparations usually have high viscosity in liquid form. Without drying, powdering and pelleting procedures, as disclosed in WO2020/097458, saccharide preparations can be difficult to mix and dose. Further, a suitable dosage form of saccharide preparations can reduce the energy use in the feed mills. In relation to human food, a suitable dosage form of saccharide preparations can enhance the manufacturing efficiency, since they can be directly used in combination of injector or extruder in the production processes.

As a result, there remains a need to provide methods for reducing the viscosity of a (liquid) composition comprising saccharides. The technical problem underlying the present application is thus to comply with this need. The technical problem is solved by providing the embodiments reflected in the claims, described in the description and illustrated in the examples and figures that follow.

### SUMMARY

Accordingly, the present invention relates to a method for reducing the viscosity of a (liquid) composition comprising a saccharide, said method comprising admixing to a composition comprising said saccharide a viscosity-reducing amount of amino acid, thereby reducing the viscosity of said composition comprising said saccharide and said viscosity-reducing amount of said amino acid when being in liquid state.

The present invention also relates to the use of an amino acid for reducing the viscosity of a (liquid) composition comprising a saccharide.

Furthermore, the present invention relates to a composition comprising a saccharide and an amino acid, said amino acid being present in said composition in amount such that it reduces the viscosity of said composition when said composition is in liquid state.

Also, the present invention relates to an animal feed or human food comprising the composition of the present invention.

Moreover, the present invention relates to a kit comprising a saccharide and an amino acid, said amino acid being present in said composition in amount such that it reduces the viscosity of said composition when said composition is in liquid state.

The present invention also relates to a method for feeding an animal comprising providing the composition, animal feed or kit of the present invention to an animal. The present invention further relates to a method for providing a human with the composition, food or kit of the present invention.

Last, but not least, the present invention relates to the use of the composition, animal feed or kit of the present invention for feeding an animal. Likewise, the present invention also relates to the use of the composition, food or kit of the present invention to a human.

### BRIEF DESCRIPTION OF THE DRAWINGS

FIG. 1 shows photos of tested oligosaccharides and HMTBA and descriptions of their state before mixing.

FIG. 2 shows photos of tested oligosaccharides and descriptions of their state after mixing with HMTBA or water.

FIG. 3 shows results of the viscosity measurements of the tested systems including oligosaccharides, 2-hydroxy-4-(methylthio) butyric acid (HMTBA) and blends thereof.

FIG. 4 shows decrease in the viscosities of other oligosaccharides compared to their corresponding blends. FIG. 4 is the enlarged lower part of FIG. 3.

### DETAILED DESCRIPTION

The present invention is described in detail in the following and will also be further illustrated by the appended examples and figures.

It is to be understood that this present disclosure is not limited to the particular embodiments described herein and as such can vary. Those of skill in the art will recognize that there are numerous variations and modifications of this present disclosure, which are encompassed within its scope.

All terms are intended to be understood as they would be understood by a person skilled in the art. Unless defined otherwise, all technical and scientific terms used herein have the same meaning as commonly understood by one of ordinary skill in the art to which the disclosure pertains.

As described herein, the present invention provides a method for reducing the viscosity of a (liquid) composition comprising a saccharide, said method comprising admixing to a composition comprising said saccharide a viscosity-reducing amount of an amino acid, thereby reducing the viscosity of said composition comprising said saccharide and said viscosity-reducing amount of said amino acid when being in liquid state.

It was surprisingly found that by admixing a certain amount of an amino acid to a saccharide, the viscosity of the otherwise viscous saccharide is reduced. Viscosity of a saccharide solution may, e.g. be an issue when such a saccharide solution may be diluted or added to, e.g. a composition. Put differently, a viscous saccharide solution may only be difficult to process on a large scale as is required commercially. However, much to their surprise, the present inventors found that admixing an amino acid to a saccharide reduces the viscosity of the otherwise viscous saccharide. This quite general and thus commonly applicable principle is demonstrated by, so to say, making bee honey pourable as is described in the Examples and shown in the Figures. In fact, admixing bee honey (being highly viscous and comprising saccharides) with an amino acid as described herein, reduces the viscosity of bee honey even at a temperature as low as 5 °C such that honey becomes conveniently pourable. Notably, at a temperature at about 5 °C bee honey is, more or less, in solid state. This example provides evidence that even almost non-pourable saccharide solutions become pourable due to the admixture of an amino acid. There can thus be no doubt about the applicability of the reduction of the viscosity of a saccharide solution by admixing it with a viscosity-reducing amount of an amino acid.

Also, as described herein, the present invention relates to the use of an amino acid for reducing the viscosity of a (liquid) composition comprising a saccharide.

Further, as described herein, the present invention provides a composition comprising a saccharide and an amino acid, said amino acid being present in said composition in amount such that it reduces the viscosity of said composition when said composition is in liquid state.

Furthermore, as described herein, the present invention provides a kit comprising a saccharide and an amino acid, said amino acid being present in said kit in amount such that it reduces the viscosity of said saccharide when being present in a composition in liquid state.

Moreover, as described herein, the present invention provides animal feed comprising the composition as described herein. Preferably, said animal is poultry. Also described herein, another preferred embodiment of the present invention provides humans food comprising the aforementioned composition

Also, as described herein, the present invention provides a method for feeding an animal, comprising providing the composition, the animal feed or the kit as described herein to an animal. Preferably, said animal is poultry.

Similarly, as described herein, the present invention provides a method for providing food to a human comprising providing the composition, the food or the kit as described herein to a human.

In addition, as described herein, the present invention provides use of the composition, the animal feed, or the kit for feeding an animal. Preferably, said animal is poultry.

Further to the aforementioned, the present invention also provides use of the composition, the food, or the kit for providing food to a human.

As used herein, the term “animal feed” (e.g., poultry feed) may refer to any compound, preparation, or mixture suitable for, or intended for intake by an animal (e.g., a chicken). Animal feed for a monogastric animal typically comprises concentrates as well as vitamins, minerals, enzymes, direct fed microbial, amino acids and/or other feed ingredients (such as in a premix) whereas animal feed for ruminants generally comprises forage (including roughage and silage) and may further comprise concentrates as well as vitamins, minerals, enzymes direct fed microbial, amino acid and/or other feed ingredients (such as in a premix). An animal feed additive (e.g., fish feed additive) is a formulated enzyme product which may further comprise e.g., vitamins, minerals, enzymes, amino acids, preservatives and/or antibiotics; i.e., a premix. The animal feed additive/premix is typically mixed in a feed mill with concentrates and/or forage such as vegetable protein, legumes or other plant material. The animal feed is typically fed as a pelleted feed to mono-gastric animals.

As used herein, the term “food”, “human food” and “food and beverage”, three of which can be used interchangeably, refer to any ingredient/product which may be intended for consumption by a human. Human food includes solid food (e.g. powder or crystalline) liquid food (e.g. as a syrup or upon resuspension in a liquid form), and food of desired consistency (e.g. whether chewable). Examples of food include, but are not limited to: snack foods, health foods, confectionary, baked goods, ready meals, frozen foods, nutritional additives, nutraceuticals, medical food, and beverages. Beverages may comprise carbonated and carbonated beverages, alcoholic and non-alcoholic beverages, ready-to-drink beverages, beverage mixes and concentrates (e.g. dry powder premixes). Examples of beverages include, but are not limited to: soft drinks, sport drinks, isotonic beverages, alcoholic beverages such as beers, ciders and wines, fruit juice and juice drinks, bottled water, iced tea, iced coffee, milk and other diary beverages, liquid supplements.

A food additive is a substance added to food which may comprise e.g., acidulants, acidity regulators, anticaking agents, antifoaming and foaming agents, antioxidants, bulking agents, food colorings, fortifying agents including e.g., vitamins, minerals, color retention agents, emulsifiers, flavorings, flavor enhancers, flour treatment agents, glazing agents, humectants, tracer gas, preservatives, stabilizers, sweeteners, thickeners and packaging. A food additive can have more than one effects, for example, salt is both a preservative as well as a flavor.

As used herein, the term “animal” may refer to any animal. Sometimes, the term “animal” and “subject” are used interchangeably. A subject may be an animal or a human. Examples of animals are humans, non-ruminants and ruminants. Ruminant animals include, for example, animals such as sheep, goats, cattle, e.g. beef cattle, cows, young calves, deer, yak, camel, llama and kangaroo. Non-ruminant animals include monogastric animals, including but not limited to pigs or swine (including, but not limited to, piglets, growing pigs, and sows); poultry such as turkeys, ducks, quail, guinea fowl, geese, pigeons (including squabs) and chicken (including but not limited to broiler chickens (referred to herein as broiles), chicks, layer hens (referred to herein as layers)); horses (including but not limited to hotbloods, coldbloods and warm bloods) crustaceans (including but not limited to shrimps and prawns) and fish including but not limited to amberjack, arapaima, barb, bass, bluefish, bocachico, bream, bullhead, cachama, carp, catfish, catla, chanos, char, cichlid, cobia, cod, crappie, dorada, drum, eel, goby, goldfish, gourami, grouper, guapote, halibut, java, labeo, lai, loach, mackerel, milkfish, mojarra, mudfish, mullet, paco, pearlspot, pejerrey, perch, pike, pompano, roach, salmon, sampa, sauger, sea bass, seabream, shiner, sleeper, snakehead, snapper, snook, sole, spinefoot, sturgeon, sunfish, sweetfish, tench, terror, tilapia, trout, tuna, turbot, vendace, walleye and whitefish. Preferred animals in the context of feed of the present invention are poultry. Preferred animals in the context of food of the present invention are human.

Preferably, in the method, use, composition, animal feed, human food or kit of the present invention, said viscosity-reducing amount of amino acid may be admixed to said composition comprising said saccharide such that said amino acid is present about 10 times more than the amount of saccharide, such as about 10 times, about 9 times, about 8 times, about 7 times, about 6 times, about 5 times, about 4 times, about 3.5 times, about 3 times, about 2 times, about 1.9 times, about 1.8 times, about 1.7 times, about 1.6 times, about 1.5 times, about 1.4 times, about 1.3 times, about 1.2 times or about 1.1 times more than the amount of saccharide. Also, said amino acid may be admixed to said composition comprising said saccharide such that the amount of said amino acid and said saccharide is equal, i.e., 1 part and 1 part, 2 parts and 2 parts, etc. The “amount” as used herein means weight of the amino acid per weight of the saccharide.

In the method, use, composition, animal feed, human food, or kit as described herein, said viscosity-reducing amount of an amino acid may preferably, for example, be admixed to said composition comprising a saccharide such that said amino acid is present in an amount of about 10 times more than the amount of said saccharide, preferably 5 times more, preferably 3.5 times more present, or 1.8 times more.

In the method, use, composition, animal feed, human food, or kit as described herein, said viscosity-reducing amount of an amino acid may preferably, for example, be admixed to said composition containing a saccharide such that said amino acid and saccharide are present in equal amounts.

Accordingly, in the method, use, composition, animal feed, human food, or kit of the present invention, by way of example, 10 parts amino acid are added to 1 part saccharide, 9 parts amino acid are added to 1 part saccharide, 8 parts amino acid are added to 1 part saccharide, 7 parts amino acid are added to 1 part saccharide, 6 parts amino acid are added to 1 part saccharide, 5 parts amino acid are added to 1 part saccharide, 4 parts amino acid are added to 1 part saccharide, 3.5 parts amino acid are added to 1 part saccharide, 3 parts amino acid are added to 1 part saccharide, 2 parts amino acid are added to 1 part saccharide, 1.9 parts amino acid are added to 1 part saccharide, 1.8 parts amino acid are added to 1 part saccharide, 1.7 parts amino acid are added to 1 part saccharide, 1.6 parts amino acid are added to 1 part saccharide, 1.5 parts amino acid are added to 1 part saccharide, 1.4 parts amino acid are added to 1 part saccharide, 1.3 parts amino acid are added to 1 part saccharide, 1.2 parts amino acid are preferably added to 1 part saccharide or 1.1 parts amino acid are added to 1 part saccharide.

Alternatively, in the method, use, composition, animal feed, human food, or kit of the present invention, 5 parts amino acid are preferably added to 1.5 part saccharide, 5 parts amino acid are added to 1.0 part saccharide, 4.9 parts amino acid are preferably added to 1.0 part saccharide (corresponding to about 83% amino acid to 17% saccharide (w/w)), 3.5 parts amino acid are added to 1.0 part saccharide (corresponding to about 78% amino acid to 22% saccharide (w/w)), 1.8 parts amino acid are added to 1 part saccharide (corresponding to about 64% amino acid to 36% saccharide (w/w)), or 1.0 part amino acid are added to 1.0 part saccharide (corresponding to about 50% amino acid to 50% saccharide (w/w)).

A “part” of an amino acid or saccharide, respectively, is any amount of said amino acid or saccharide.

Thus, in the alternative, in the method, use, composition, animal feed, human food, or kit of the present invention, the ratio between amino acid and saccharide may preferably also be given as, e.g., 90% amino acid to 10% saccharide (w/w), 83% amino acid to 17% saccharide (w/w) (corresponding to 4.9 parts amino acid to 1.0 part saccharide), 78% amino acid to 22% saccharide (w/w) (corresponding to 3.5 parts amino acid to 1.0 part saccharide), 64% amino acid to 36% saccharide (w/w) (corresponding to 1.8 parts amino acid to 1.0 part saccharide), or 50% amino acid to 50% saccharide (w/w) (corresponding to 1.0 parts amino acid to 1.0 part saccharide).

Without being bound by theory, the admixed amino acid is deemed to have beneficial effects on animal performance. Advantageously, said admixed amino acid may already be approved as additives in animal feed, such as methionine, lysine or threonine. The admixing of amino acid causes advantageously no additional concern.

In any one of the method, use, composition, animal feed, human food, or kit as described herein, the composition of the present invention comprising a saccharide is preferably in solid state when said viscosity-reducing amount of an amino acid is admixed thereto.

In any one of the method, use, composition, animal feed, human food, or kit as described herein, the composition of the present invention comprising a saccharide is preferably in liquid state when said viscosity-reducing amount of an amino acid is admixed thereto.

In any one of the method, use, composition, animal feed, human food, or kit as described herein, said viscosity-reducing amount of an amino acid admixed to the composition of the present invention comprising a saccharide is preferably in solid state.

In any one of the method, use, composition, animal feed, human food, or kit as described herein, said viscosity-reducing amount of an amino acid admixed to the composition of the present invention comprising a saccharide is preferably in liquid state.

In any one of the method, use, composition, animal feed, human food, or kit as described herein, said composition comprising a saccharide is in solid state when said viscosity-reducing amount of an amino acid is admixed thereto and said viscosity-reducing amount of an amino acid admixed to the composition of the present invention comprising a saccharide is preferably in solid state.

In any one of the method, use, composition, animal feed, human food, or kit as described herein, said composition comprising a saccharide is in liquid state when said viscosity-reducing amount of an amino acid is admixed thereto and said viscosity-reducing amount of an amino acid admixed to the composition of the present invention comprising a saccharide is preferably in liquid state.

In any one of the method, use, composition, animal feed, human food, or kit as described herein, the composition of the present invention comprising a saccharide is preferably in solid state when said viscosity-reducing amount of an amino acid is admixed thereto and said viscosity-reducing amount of an amino acid admixed to said composition comprising a saccharide is preferably in liquid state.

In any one of the method, use, composition, animal feed, human food, or kit as described herein, the composition of the present invention comprising a saccharide is preferably in liquid state when said viscosity-reducing amount of an amino acid is admixed thereto and said viscosity-reducing amount of an amino acid admixed to said composition comprising a saccharide is preferably in solid state.

More preferably, in any one of the method, use, composition, animal feed, human food, or kit as described herein, the composition of the present invention comprising a saccharide is in liquid state when said viscosity-reducing amount of an amino acid is admixed thereto and said viscosity-reducing amount of an amino acid admixed to said composition comprising a saccharide is in liquid state.

Advantageously, the viscosity-reducing amount of an amino acid is a saturated solution or will become a saturated solution when admixed in solid state and then being dissolved by a solvent, such a water or a liquid composition comprising a saccharide.

In practice, those skilled in the art can determine a concentration of an amino acid in liquid state, which is a saturated concentration of said amino acid in a solvent system, such as a liquid composition. Put differently, an excess amount of solvent used to dissolve the selected amino acid into liquid form is deliberately avoided. Therefore, the applicability of the reduction of the viscosity of a saccharide solution by admixing it with a viscosity-reducing amount of an amino acid relies on said amino acid, not on the amount of solvent of said liquid amino acid composition.

As mentioned, the amino acid admixed to said saccharide is advantageously a saturated solution when added in liquid state to said saccharide. Said saccharide may be in solid state and will thus be dissolved by the amino acid being in liquid state or will be dissolved by the amino acid being in liquid state and an additional solvent, such as water. . . . Alternatively, said saccharide is already in liquid state in a (liquid) composition when said amino acid is added in liquid state.

Alternatively, the amino acid admixed to said saccharide is advantageously a saturated solution when being added in solid state to a saccharide and being then dissolved in a liquid composition comprising a saccharide.

A “saturated solution” when used herein is a solution that contains the maximum amount of a solute-in the context of the present invention an amino acid-that can be dissolved under the condition at which the solution exists. A saturated solution may be prepared by dissolving, e.g. an amino acid in solid state in water. Alternatively, a saturated solution of an, e.g. amino acid may already be the product of the synthesis of an amino acid if said amino acid exists only in liquid form.

The degree of saturation, preferably the maximum saturation of an amino acid in solution can be tested by means and methods known in the art, ideally at a temperature of 25 °C. For example, if a solution is unsaturated, saturated, or supersaturated, can be determined by adding a small amount of solute, particularly an amino acid. If the solution is unsaturated, the solute, particularly an amino acid will dissolve. If the solution is saturated, the solute, particularly an amino acid will not dissolve. If the solution is supersaturated, crystals will very quickly form around the added solute, particularly an amino acid.

In any one of the method, use, composition, animal feed, human food, or kit as described herein, said saccharide comprised by the composition of the present invention is preferably an oligosaccharide. In particular, in any one of the method, use, composition, animal feed, human food, or kit as described herein, said composition comprising a saccharide when being in liquid state has a viscosity of at least 250 mPa*s (e.g., at least 300 mPa*s, at least 350 mPa*s, at least 400 mPa*s, at least 450 mPa*s, at least 500 mPa*s, at least 550 mPa*s, at least 600 mPa*s, at least 650 mPa*s, at least 750 mPa*s) at 25 °C, before said viscosity-reducing amount of an amino acid is admixed.

Preferably, the composition of the present invention comprising a saccharide has been selected to be one when being in liquid state has a viscosity ranging from about 5000 mPa*s to about 80000 mPa*s at 5 °C.

The composition of the present invention comprising a saccharide is intended to be used at a temperature ranging from 5-40 °C; preferably from 5-30 °C; more preferably from 9-26 °C; more preferably from 19-26 °C.

The viscosity of the composition of the present invention comprising a saccharide at 5-40 °C is intended to be reduced by admixed said viscosity-reducing amount of an amino acid; preferably from 5-30 °C; more preferably from 9-26 °C; more preferably from 19-26 °C.

In any one of the method, use, composition, animal feed, human food, or kit as described herein, the viscosity of a composition comprising a saccharide, either before or after the admixture of said viscosity-reducing amount of an amino acid, is preferably determined by using DIN concentric cylinders, Peltier steel-113353 at a shear rate of 25/s at 25 °C.

In any one of the method, use, composition, animal feed, human food, or kit as described herein, the device for determining viscosity is preferably a AR-G2 magnetic bearing rheometer from TA instruments.

The term “viscosity-reducing” as used herein refers to an amount of an amino acid which is required to reduce the viscosity of the composition comprising a saccharide. A skilled person can readily determine such an amount by, e.g. determining the viscosity of a composition comprising a saccharide prior to admixing an amino acid to the composition and after admixing it. Preferably, the viscosity is determined at 25 °C prior to and after as described herein. Preferred amounts of an amino acid for reducing the viscosity of a composition comprising a saccharide, i.e., a “viscosity-reducing” amount of an amino acid are described herein.

The term “saccharide” refers to monosaccharides, di-, oligo- and polysaccharides, which are made up of n monosaccharide units linked by glycosidic bonds. Said term also includes derivatives of saccharides. Said term may be interchangeably used herein with the term “glycan”.

The term “oligosaccharide” refers to a monosaccharide or a compound containing two or more monosaccharide subunits linked by glycosidic bonds. As such, an oligosaccharide includes a regular monosaccharide or a derivatized (chemically or enzymatically modified) monosaccharide unit, e.g., an anhydro-monosaccharide; or a compound containing two or more monosaccharide subunits, wherein one or more monosaccharide subunits are optionally, independently replaced by one or more anhydro-subunits. An oligosaccharide can be functionalized. As used herein, the term oligosaccharide encompasses all species of the oligosaccharide, wherein each of the monosaccharide subunit in the oligosaccharide is independently and optionally functionalized and/or replaced with its corresponding anhydro-monosaccharide subunit. Such an oligosaccharide comprising anhydro-subunits and/or similar dehydration products can be a preparation disclosed in WO2020/097458. Preferred oligosaccharides in the context of the present invention are the oligosaccharides comprising anhydro-subunits and/or similar dehydration products in liquid state that are disclosed in. WO2020/097458.

As used herein, the term “polysaccharide” refers to polymers comprising a backbone comprising monosaccharide repeating units and/or derivatized monosaccharide repeating units linked by glycosidic bonds. This term is commonly used only for those containing more than ten monosaccharide repeating units.

As used herein, the term “monosaccharide subunit” and “monosaccharide repeating unit” are used interchangeably. A “monosaccharide subunit” refers to a monosaccharide monomer in an oligosaccharide. For an oligosaccharide having a degree of polymerization of 1, the oligosaccharide can be referred to as a monosaccharide subunit or monosaccharide. For an oligosaccharide having a degree of polymerization of 2 or higher, its monosaccharide subunits are linked via glycosidic bonds. Monosaccharide includes typically cyclic pentoses, in particular C5 aldoses or ketoses, or cyclic hexoses, in particular C8 aldoses or ketoses. Non-limiting examples of C5-C8 aldoses include allose, altrose, glucose, mannose, gulose, idose, galactose, talose, ribose, arabinose, xylose, and lyxose. Non-limiting examples of C5-C8 ketoses include ribulose, xylulose, fructose, sorbose and tagatose. As used herein, the term “monosaccharide” includes also derivatized monosaccharides.

The polysaccharide may be a homopolysaccharide or heteropolysaccharide, preferably a homopolysaccharide.

The polysaccharide may be modified or unmodified.

The polysaccharide is selected from the group consisting of starches, modified starches, amylopectin, modified amylopectin, amylose, modified amylose, chitosan, chitin, guar gum, modified guar gum, locust bean gum, tara gum, konjac gum, konjac flour, fenugreek gum, mesquite gum, aloe mannans, modified cellulose, oxidized polysaccharides, sulfated polysaccharides, cationic polysaccharides, arabic gum, karaya gum, xanthan, kappa, iota or lambda carrageenans, agar-agar, alginates, callose, laminarin, chrysolaminarin, xylan, mannan, galactomannan, hemicellulose, pectin, arabinoxylan, xanthan gum, nigeran, isolichenan, laminaran, lichenan, glycogen, pullulan, dextran, pustulan, inulin, grass levans, carrageenan, galactocarolose, rhodymenan, fucoidan, agarose, porphyran, alginic acid, keratosulphate, chondroitin, chrondroitin sulphates, heparin and cellulose.

A “mixture” when referred to herein may be a mixture of amino acids or saccharides. Thus, an amino acid when used in the context of the method, use, composition, animal feed, human food, or kit as described herein may be a mixture of amino acids. Similarly, a saccharide when used in the context of the method, use, composition, animal feed, human food, or kit as described herein may be a mixture of saccharides.

The term “mixture”, unless defined otherwise, in general, refers to one product of mechanically blending or mixing chemical substances such as elements or compounds, without chemical bonding or other chemical change, so that each ingredient substance or component of resulted mixture retains its chemical properties and compositions. Some mixtures except azeotropes can be separated into their components by using physical means.

As used herein, a mixture may comprise two or more saccharides (e.g., two, three, four, five or more). A mixture may comprise two or more amino acids (e.g., two, three, four, five or more). A composition comprising saccharides and amino acids may comprise one or a mixture of saccharides and one or a mixture of amino acids (e.g., a saccharide with two amino acids, a saccharide with three amino acids, two saccharides with two amino acids, two saccharides with three amino acids, three saccharides with two amino acids, three saccharides with an amino acid). Some mixtures of saccharides may not be determined by measurement before use with regard to the number of comprised saccharides. Some mixtures of saccharides may vary in the number of comprised saccharides or even in comprised saccharides from time to time, such as natural product honey. It is further noted that as used herein, the singular forms “a”, “an”, and “the”, include plural references unless the context clearly indicates otherwise. For example, “a (liquid) composition comprising a saccharide” includes “a (liquid) composition comprising a mixture of saccharides”.

In any one of the method, use, composition, animal feed, human food, or kit as described herein, the naturally-occurring amino acid may preferably be a non-polar amino acid such as alanine, valine, leucine, glycine, isoleucine, methionine, tryptophane, phenylalanine, proline, preferably methionine, tryptophane, glycine, isoglyine, valine or proline, more preferably methionine, valine or tryptophane, with methionine being particularly preferred.

An “amino acid” when used herein encompasses an organic compound having a —CH(NH₃)— COOH group.

In any one of the method, use, composition, animal feed, human food, or kit as described herein, the naturally-occurring amino acid may preferably be a polar amino acid such as serine, threonine, cysteine, asparagine, glutamine, tyrosine, preferably threonine or glutamine, more preferably threonine.

In any one of the method, use, composition, animal feed, human food, or kit as described herein, the naturally-occurring amino acid may preferably be an acidic amino acid such as aspartic acid, glutamic acid, preferably glutamic acid.

In any one of the method, use, composition, animal feed, human food, or kit as described herein, the naturally-occurring amino acid may preferably be a basic amino acid such as arginine, lysine, histidine, preferably lysine or arginine, more preferably lysine.

In any one of the method, use, composition, animal feed, human food, or kit as described herein, the unnatural amino acid may preferably be an R-amino acid, a homo amino acid, an N-methyl amino acid, an alpha-methyl amino acid, a beta2 amino acid, a beta3 amino acid, or a beta3 homo amino acid. Examples are hydroxyproline (Hyp), beta-alanine, citrulline (Cit), ornithine (Orn), norleucine (Nle), 3-nitrotyrosine, nitroarginine, pyroglutamic acid (Pyr).

In any one of the method, use, composition, animal feed, human food, or kit as described herein, the amino acid is preferably a functionalized amino acid, preferably said functionalized amino acid is an esterified amino acid or a hydroxylated amino acid as for example hydroxy-methionine or lysin or an amino acid analogue as for example 2-hydroxy-4-(methylthio) butanoate (HMTBA). Functionalized amino acid refers to amino acid with functionalization obtainable on a large scale, e.g., esterification, acetylation, carboxylation and carbamoylation. The functionalized amino acid may be an amino acid optionally substituted with one or more (C₁-C₆)alkyl groups (R or R′) at acid or amine groups of the amino acid. The functionalized amino acid may be an amino acid optionally substituted with one or more acetyl groups (CH₃CO—) at amine groups of the amino acid. The functionalized amino acid may be an amino acid optionally substituted with one or more carboxyl groups (HOCO—) at amine groups of the amino acid. The functionalized amino acid may be an amino acid with carbamoyl groups (NH₂CO—) at amine groups of the amino acid.

The functionalization including esterification and acetylation may be present once or twice in an amino acid. The functionalization including esterification and acetylation may be present once or twice in an amino acid to form mono- or difunctionalized amino acid. The functionalization including esterification and acetylation may be present more than twice, if more than two acid or amine groups are present.

In any one of the method, use, composition, animal feed, human food, or kit as described herein, the amino acid may preferably be an amino acid analogue, a naturally-occurring amino acid, an unnatural amino acid or a functionalized amino acid or a salt thereof.

Unless otherwise indicated, the term “alkyl” by itself or as part of another term in general refers to a substituted or unsubstituted straight chain or branched, saturated hydrocarbon having the indicated number of carbon atoms; e.g., “—(C₁-C₃)alkyl” or “—(C₁-C₆)alkyl” refer to an alkyl group having from 1 to 3 or 1 to 6 carbon atoms, respectively). When the number of carbon atoms is not indicated, the alkyl group may have from 1 to 6 carbon atoms. Representative straight chain —(C₁-C₆)alkyl groups include, but are not limited to, -methyl, -ethyl, -n-propyl, -n-butyl, -n-pentyl and -n-hexyl; branched —(C₁-C₆)alkyl groups include, but are not limited to, -isopropyl, -sec-butyl, -isobutyl, -tert-butyl, -isopentyl, and -2-methyl butyl. In some aspects, an alkyl group may be unsubstituted. Optionally, an alkyl group may be substituted, such as e.g. with one or more groups.

Unless otherwise indicated, the term “alkylene” by itself or as part of another term, in general refers to a substituted or unsubstituted branched or straight chain, saturated hydrocarbon radical of the stated number of carbon atoms, preferably 1-6 carbon atoms (—(C₁-C₆)alkylene-) or preferably 1 to 4 carbon atoms (—(C₁-C₄)alkylene-), and having two monovalent radical centers derived by the removal of two hydrogen atoms from the same or two different carbon atoms of a parent alkane. When the number of carbon atoms is not indicated, the alkylene group may have from 1 to 6 carbon atoms. Typical alkylene radicals include, but are not limited to: methylene (—CH₂—), 1,2-ethylene (—CH₂CH₂—), 1,3-n-propylene (—CH₂CH₂CH₂—), and 1,4-n-butylene (—CH₂CH₂CH₂CH₂—). In some aspects, an alkylene group may be unsubstituted. Optionally, an alkylene group may be substituted, such as e.g. with one or more groups.

Unless otherwise indicated, the term “aryl”, by itself or as part of another term, in general means a substituted or unsubstituted monovalent carbocyclic aromatic hydrocarbon radical of 6 to 20 carbon atoms (preferably 6 to 14 carbon atoms, more preferably 6 to 10 carbon atoms, in very preferred embodiments 6 carbon atoms) derived by the removal of one hydrogen atom from a single carbon atom of a parent aromatic ring system. Some aryl groups are represented in the exemplary structures as “Ar”. Typical aryl groups include, but are not limited to, radicals derived from benzene, substituted benzene, naphthalene, anthracene, and biphenyl. An exemplary aryl group is a phenyl group. In some aspects, an aryl group may be unsubstituted. Optionally, an aryl group may be substituted, such as e.g. with one or more groups.

The term “halogen”, unless defined otherwise, in general refers to elements of the 7th main group; preferably fluorine, chlorine, bromine and iodine; more preferably fluorine, chlorine and bromine; even more preferably, fluorine and chlorine.

The term “substituted”, “optionally substituted”, “optionally may be substituted” or the like, unless otherwise indicated, in general means that one or more hydrogen atoms can be each independently replaced with a substituent. Typical substituents include, but are not limited to, —X, —R, —OH, —OR, —SR, —SH, —NHR, —NRR′, —NR₂R′, —(CH₂)₂OR, —(CH₂)₂NR, —NRC(═O)R′, —C(═O)R, —C(═O)NRR′, —C(═O)X, —C(═S)R, —CO₂R, —C(═S)OR, —C(═O)SR, —C(═S)SR, —C(═O)NRR′, —C(═S)NRR′, —C(═NR)NRR′, glucosyl-, galactosyl-, or glucuronyl-, where each X is independently a halogen: —F, —Cl, —Br, or —I; and each R and R′ is independently —H, —(C₁-C₆)alkyl —(C₆-C₂₀)aryl, (such as e.g. —(C₆-C₁₀)aryl or, preferably, —C₆-aryl. Typical substituents also include (═O).

The amino acid analogue is an analogue having a structure of formula (I):

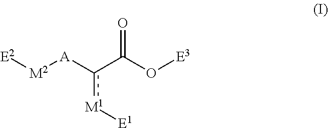

or a salt thereof;
wherein:
M₁, M₂ are each independently selected from the group consisting of O, NH, S or CH₂; E₁, E₂, E₃ are each independently selected from the group consisting of hydrogen, (C₁-C₆)alkyl, (C₆-C₁₀)aryl, acetyl, carbamoyl, carboxyl, —(CH₂)₂OR, or —(CH₂)₂NHR;
A is (C1-C₆) alkylene, wherein the (C₁-C₆)alkylene may be optionally substituted with one or more substituents selected from the group consisting of halogen, —R, —OH, —OR, —SR, —SH, —NHR, —NRR′, —NR₂R′, —(CH₂)₂OR, —(CH₂)₂NR, —NRC(═O)R′, —C(═O)R, —C(═O)NRR′, —C(═O)X, —C(═S)R, —CO₂R, —C(═S)OR, —C(═O)SR, —C(═S)SR, —C(═O)NRR′, —C(═S)NRR′, —C(═NR)NRR′, glucosyl-, galactosyl, and glucuronyl;
R and R′ may be the same or different, are independently selected from hydrogen, (C₁-C₆)alkyl or (C₆-C₁₀)aryl;
[symbol] is a double bond; or is a bond;
E¹ is absent [symbol] when is a double bond; or
E¹ is as defined herein when [symbol] is a bond;
M¹ is O when [symbol] is a double bond; or
M¹ is as defined herein when [symbol] is a bond.

In any one of the method, use, composition, animal feed, human food, or kit as described herein, preferably, the amino acid analogue is preferably an analogue of methionine, lysine, glutamic acid or threonine; more preferably, the amino acid analogue is an analogue of methionine or lysine; still more preferably, the amino acid analogue is an analogue of methionine.

In any one of the method, use, composition, animal feed, human food, or kit as described herein, still more preferably, the analogue of methionine is 2-hydroxy-4-(methylthio)butyric acid (HMTBA).

This is expressed in formula (I) wherein [symbol] is a bond, M¹ is O, E¹ is H, E³ is H, A is ethylene, M² is S and E² is —CH₃.

Still more preferably, the analogue of methionine is 2-hydroxy-4-(methylthio)butyric acid (HMTBA) having a structure of formula (Ia):

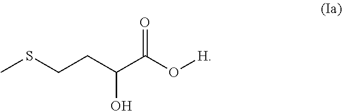

Still more preferably, the analogue of methionine is ethyl 2-hydroxy-4-(methylsulfanyl)butanoate, i.e., wherein [symbol] is a bond, M¹ is O, E¹ is H, E³ is —CH₂CH₃, A is ethylene, M² is S and E² is —CH₃.

Still more preferably, the analogue of methionine is ethyl 2-hydroxy-4-(methylsulfanyl)butanoate having a structure of formula (Ib):

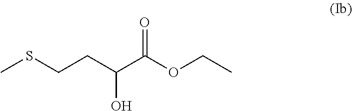

Still more preferably, the analogue of methionine is isopropyl 2-hydroxy-4-(methylsulfanyl)butanoate, i.e., wherein [symbol] is a bond, M¹ is O, E¹ is H, E³ is —CH₂(CH₃)₂, A is ethylene, M² is S and E² is —CH₃.

Still more preferably, the analogue of methionine is isopropyl 2-hydroxy-4-(methylsulfanyl)butanoate having a structure of formula (Ic):

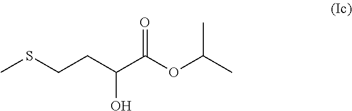

Still more preferably, the analogue of methionine is 4-methyl-2-oxopentanoic acid,
i.e., wherein [symbol] is a double bond, M¹ is O, E¹ is absent, E³ is H, A is methylene, M² is CH₂ and E² is —CH₂(CH₃)₂.

Still more preferably, the analogue of methionine is 4-methyl-2-oxopentanoic acid having a structure of formula (Id):

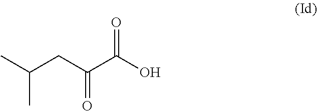

Still more preferably, the analogue of methionine is 2-oxo-3-phenylpropanoic acid, i.e., wherein [symbol] is a double bond, M¹ is O, E¹ is absent, E³ is H, A is methylene, M² is CH₂ and E² is —(C₆H₅).

Still more preferably, the analogue of methionine is 2-oxo-3-phenylpropanoic acid having a structure of formula (Ie):

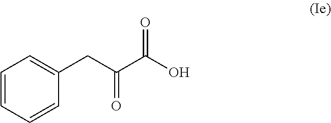 [SMILES: O=C(O)C(=O)Cc1ccccc1]

Still more preferably, the analogue of methionine is 3-methyl-2-oxopentanoic acid, i.e., wherein [symbol] is a double bond, M¹ is O, E¹ is absent, E³ is H, A is ethylene, M² is CH₂ and E² is H.

Still more preferably, the analogue of methionine is 3-methyl-2-oxopentanoic acid having a structure of formula (If):

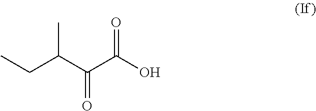

Still more preferably, the analogue of methionine is 3-methyl-2-oxobutanoic acid, i.e., wherein [symbol] is a double bond, M¹ is O, E¹ is absent, E³ is H, A is substituted methylene, M² is CH₂ and E² is H.

Still more preferably, the analogue of methionine is 3-methyl-2-oxobutanoic acid having a structure of formula (Ig):

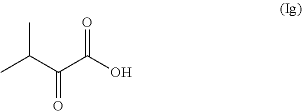

Still more preferably, the analogue of lysine is (2-aminoethyl)cysteine, i.e., wherein [symbol] is a bond, M¹ is NH, E¹ is H, E³ is H, A is methylene, M² is S and E² is —(CH₂)₂NH₂.

Still more preferably, the analogue of lysine is (2-aminoethyl)cysteine having a structure of formula (Ih):

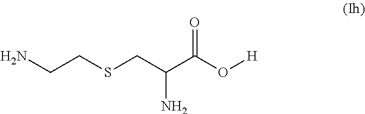

Still more preferably, the analogue of lysine is 2,6-diamino-5-hydroxyhexanoic acid, i.e., wherein [symbol] is a bond, M¹ is NH, E¹ is H, E³ is H, A is C₄-Alkylene, substituted with hydroxy group, M² is NH and E² is H.

Still more preferably, the analogue of lysine is 2,6-diamino-5-hydroxyhexanoic acid having a structure of formula (Ii):

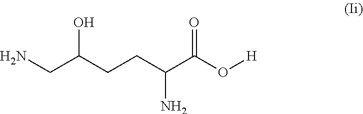 [SMILES: NCC(O)CCC(N)C(=O)O]

Still more preferably, the analogue of lysine is methyl lysinate,
i.e., wherein [symbol] is a bond, M¹ is NH, E¹ is H, E³ is —CH₃, A is C₄-Alkylene, M² is NH and E² is H.

Still more preferably, the analogue of lysine is methyl lysinate having a structure of formula (Ij):

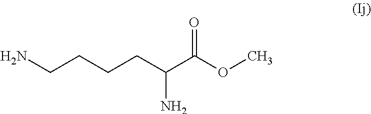

### Items of the Invention

The present invention may also be summarized by the following items:
1. A method for reducing the viscosity of a (liquid) composition comprising a saccharide, said method comprising admixing to a composition comprising said saccharide a viscosity-reducing amount of an amino acid, thereby reducing the viscosity of said composition comprising said saccharide and said viscosity-reducing amount of said amino acid when being in liquid state.
2. Use of an amino acid for reducing the viscosity of a (liquid) composition comprising a saccharide.
3. The method or use of any one of the preceding items, wherein said composition comprising a saccharide is in solid state when said viscosity-reducing amount of an amino acid is admixed thereto.
4. The method or use of any one of the preceding items, wherein said composition comprising a saccharide is in liquid state when said viscosity-reducing amount of an amino acid is admixed thereto.
5. The method or use of any one of the preceding items, wherein said viscosity-reducing amount of an amino acid admixed to said composition comprising a saccharide is in solid state.
6. The method or use of any one of the preceding items, wherein said viscosity-reducing amount of an amino acid admixed to said composition comprising a saccharide is in liquid state.
7. The method or use of any one of the preceding items, wherein said composition comprising a saccharide is in solid state when said viscosity-reducing amount of an amino acid is admixed thereto and said viscosity-reducing amount of an amino acid admixed to said composition comprising a saccharide is in solid state.
8. The method or use of any one of the preceding items, wherein said composition comprising a saccharide is in liquid state when said viscosity-reducing amount of an amino acid is admixed thereto and said viscosity-reducing amount of an amino acid admixed to said composition comprising a saccharide is in liquid state.
9. The method or use of any one of the preceding items, wherein said composition comprising a saccharide is in solid state when said viscosity-reducing amount of an amino acid is admixed thereto and said viscosity-reducing amount of an amino acid admixed to said composition comprising a saccharide is in liquid state.
10. The method or use of any one of the preceding items, wherein said composition comprising a saccharide is in liquid state when said viscosity-reducing amount of an amino acid is admixed thereto and said viscosity-reducing amount of an amino acid admixed to said composition comprising a saccharide is in solid state.
11. The method or use of any one of the preceding items, wherein said saccharide comprised by said composition is an oligosaccharide.
12. The method or use of any one of the preceding items, wherein said composition comprising a saccharide when being in liquid state has a viscosity of at least 250 mPa*s at 25 °C before said viscosity-reducing amount of an amino acid is admixed.
13. The method or use of any one of the preceding items, wherein said viscosity-reducing amount of an amino acid is admixed to said composition containing a saccharide such that said amino acid is present in an amount of about 10 times more than the amount of said saccharide, preferably 5 times more, preferably 3.5 times more present, or 1.8 times more.
14. The method or use of any one of the preceding items, wherein said viscosity-reducing amount of an amino acid is admixed to said composition containing a saccharide such that said amino acid and saccharide are present in equal amounts.
15. The method or use of item 13 or 14, wherein said amount of said amino acid and said saccharide is weight of the amino acid per weight of the saccharide.
16. The method or use of any one of the preceding items, wherein the viscosity of the composition comprising a saccharide, either before or after the admixture of said viscosity-reducing amount of an amino acid, is determined by using DIN concentric cylinders, Peltier steel—113353 at a shear rate of 25/s at 25 °C.
17. The method or use of any one of the preceding items, wherein the device for determining viscosity is a AR-G2 magnetic bearing rheometer from TA instruments.
18. The method or use of any one of the preceding items, wherein the amino acid is an amino acid analogue, a naturally-occurring amino acid, an unnatural amino acid or a functionalized amino acid, or a salt thereof.
19. The method or use of any one of the preceding items, wherein the amino acid analogue is an analogue of methionine.
20. The method or use of item 17, wherein the analogue of methionine is 2-hydroxy-4-(methylthio)butyric acid (HMTBA).
21. The method or use of any one of the preceding items, wherein the naturally-occurring amino acid is a non-polar amino acid such as alanine, valine, leucine, glycine, isoleucine, methionine, tryptophane, phenylalanine, proline, preferably methionine, tryptophane, glycine, isoglyine, valine or proline, more preferably methionine, valine or tryptophane, with methionine being particularly preferred.
22. The method or use of any one of the preceding items, wherein the naturally-occurring amino acid is a polar amino acid such as serine, threonine, cysteine, asparagine, glutamine, tyrosine, preferably threonine or glutamine, more preferably threonine.
23. The method or use of any one of the preceding items, wherein the naturally-occurring amino acid is an acidic amino acid such as aspartic acid, glutamic acid, preferably glutamic acid.
24. The method or use of any one of the preceding items, wherein the naturally-occurring amino acid is a basic amino acid such as arginine, lysine, histidine, preferably lysine or arginine, more preferably lysine.
25. The method or use of any one of the preceding items, wherein the unnatural amino acid is an R-amino acid.
26. The method or use of any one of the preceding items, wherein the functionalized amino acid is an esterified amino acid.
27. A composition comprising a saccharide and an amino acid, said amino acid being present in said composition in amount such that it reduces the viscosity of said composition when said composition is in liquid state.
28. The composition of item 27, wherein said amino acid is present is said composition in an amount of about 10 times more than the amount of said saccharide, preferably 5 times more, preferably 3.5 times more present, or 1.8 times more.
29. The composition of item 27, wherein said amino acid and said saccharide are present in said composition in equal amounts.
30. Animal feed or human food comprising the composition of any one of items 27 to 29.
31. A kit comprising a saccharide and an amino acid, said amino acid being present in said kit in amount such that it reduces the viscosity of said saccharide when being present in a composition in liquid state.
32. A method for feeding an animal comprising providing the composition of any one of items 27 to 29, the animal feed of item 30 or the kit of item 31 to an animal.
33. Use of the composition of any one of items 27 to 29, the animal feed of item 30, or the kit of item 31 for feeding an animal.
34. The animal feed of item 30, the kit of item 31, the method of item 32 or the use of item 33, wherein said animal is poultry.
35. The human food of item 30, the kit of item 31, the method of item 32 or the use of item 33, wherein said animal is human.

Unless otherwise stated, the following terms used in this document, including the description and claims, have the definitions given below.

Those skilled in the art will recognize, or be able to ascertain, using not more than routine experimentation, many equivalents to the specific embodiments of the invention described herein. Such equivalents are intended to be encompassed by the present invention.

It is to be noted that as used herein, the singular forms “a”, “an”, and “the”, include plural references unless the context clearly indicates otherwise. Thus, for example, reference to “an amino acid” includes one or more of such different amino acids and reference to “the method” includes reference to equivalent steps and methods known to those of ordinary skill in the art that could be modified or substituted for the methods described herein.

Unless otherwise indicated, the term “at least” preceding a series of elements is to be understood to refer to every element in the series. Those skilled in the art will recognize or be able to ascertain using no more than routine experimentation, many equivalents to the specific embodiments of the invention described herein. Such equivalents are intended to be encompassed by the present invention.

The term “and/or” wherever used herein includes the meaning of “and”, “or” and “all or any other combination of the elements connected by said term”.

The term “about” or “approximately” as used herein means within 20%, preferably within 10%, and more preferably within 5% of a given value or range. It includes, however, also the concrete number, e.g., about 20 includes 20.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integer or step. When used herein the term “comprising” can be substituted with the term “containing” or “including” or sometimes when used herein with the term “having”.

When used herein “consisting of” excludes any element, step, or ingredient not specified in the claim element. When used herein, “consisting essentially of” does not exclude materials or steps that do not materially affect the basic and novel characteristics of the claim.

In each instance herein any of the terms “comprising”, “consisting essentially of” and “consisting of may be replaced with either of the other two terms.

It should be understood that this invention is not limited to the particular methodology, protocols, material, reagents, and substances, etc., described herein and as such can vary.

The terminology used herein is for the purpose of describing particular embodiments only, and is not intended to limit the scope of the present invention, which is defined solely by the claims.

All publications cited throughout the text of this specification (including all patents, patent applications, scientific publications, manufacturer's specifications, instructions, etc.) are hereby incorporated by reference in their entirety. Nothing herein is to be construed as an admission that the invention is not entitled to antedate such disclosure by virtue of prior invention. To the extent the material incorporated by reference contradicts or is inconsistent with this specification, the specification will supersede any such material.

### EXAMPLES

An even better understanding of the present invention and of its advantages will be evident from the following examples, offered for illustrative purposes only. The examples are not intended to limit the scope of the present invention in any way. The present invention is limited only by the claims.

### Viscosity Evaluation of a Mixture of Oligosaccharides and a Liquid Analogue of Methionine

The objective of the following experiments is to evaluate the behaviour of mixtures of oligosaccharides with a liquid analogue of methionine (HMTBA) by comparing it to the oligosaccharides and HMTBA, respectively.

### Materials and Methods

For the above-mentioned objective, following materials were tested. Their descriptions were for the state of matter observed at room temperature:
Human Milk Oligosaccharide (HMO)
   Lot number 20161001
   Powder
Maestro Glycan
   Lot number UT19070214
   Liquid
Honey
   Lot number 158060
   Liquid
Liquid analogue of methionine (HMTBA)
   Lot number 782026721
   Liquid

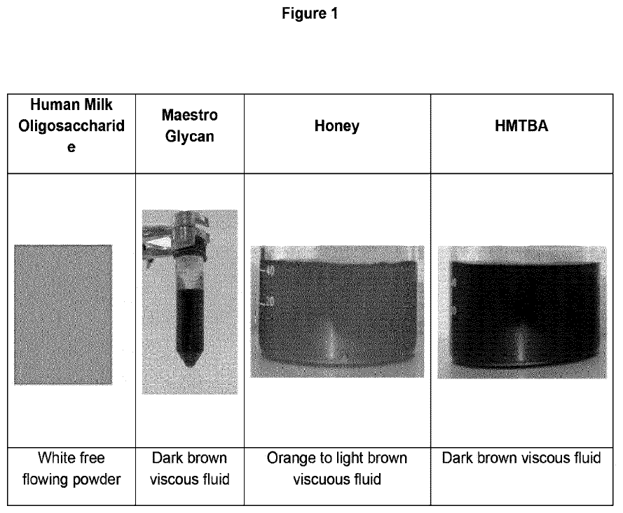

The photos of the tested oligosaccharides and their appearance/state before admixing with HMTBA were shown in FIG. 1.

Blends of the tested oligosaccharides and HMTBA were prepared as follows:
1. Addition of thicker liquid (by visual evaluation) in Erlenmeyer flask
2. Measurement of temperature
3. Start of stirring
4. Addition of the thinner liquid during stirring with a magnetic stirrer (for ca.1 minute, at 500 rpm)
5. Measurement of temperature
6. Stirring for additional 5 minutes

The thicker liquid determined by visual evaluation was placed in an Erlenmeyer flask and the temperature thereof before mixing was measured. This thicker liquid was stirred using a magnetic stirrer at a velocity of 500 rpm. During stirring, the thinner liquid was added thereto and the blend was stirred for about 1 minute. Afterwards, the temperature of the blend was measured. The blend was stirred further for another 5 minutes.

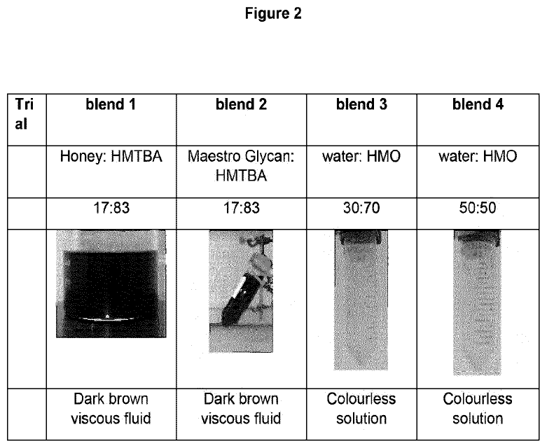

The photos of the tested oligosaccharides and their appearance/state after admixing with HMTBA or water were shown in FIG. 2.

### Viscosity Analysis

Viscosity was evaluated using a Rheometer AR-G2 (TA Instruments, Waters GmbH, Eschborn).

Determination of viscosity changes were performed using a temperature ramp as follows 40 °C—25 °C—15 °C—10 °C—5 °C at a shear rate of 25/s with DIN concentric cylinder, Peltier Steel—113353 geometry.

### Results

It was surprising to observe that the blends of the oligosaccharide and HMTBA took the dark brown viscous appearance with a significant lower viscosity that physically resembled closer to that of HMTBA. No significant changes in the temperature were registered after the blending. No foaming, no de-mixing or sedimentation was observed after the blending. The blends looked physically stable.

Mixing HMO with water was also performed without any observation of specific physical change.

The viscosity was further evaluated using a Rheometer as previously described. The results were shown in Table 1.

TABLE 1
Viscosity of different fluids measured in unit of mPa*s.

| | | Pure compounds | | | Blends | | | |
|---|---|---|---|---|---|---|---|---|
| | | Maestro | | | 17:83 | 17:83 Maestro | 30:70 | 50:50 |
| | | Glycan | Honey | HMTBA | Honey:HMTBA | Glycan:HMTBA | water:HMO | water:HMO |
| 40 | °C | 548 | 1762 | 52 | 86 | 72 | 211 | 12 |
| 25 | °C | 795 | 3461 | 74 | 130 | 104 | 469 | 23 |
| 15 | °C | 1666 | 10440 | 132 | 249 | 186 | 900 | 38 |
| 10 | °C | 2895 | 23993 | 202 | 400 | 287 | 1337 | 51 |
| 5 | °C | 5170 | 75510 | 315 | 657 | 448 | 2115 | 70 |

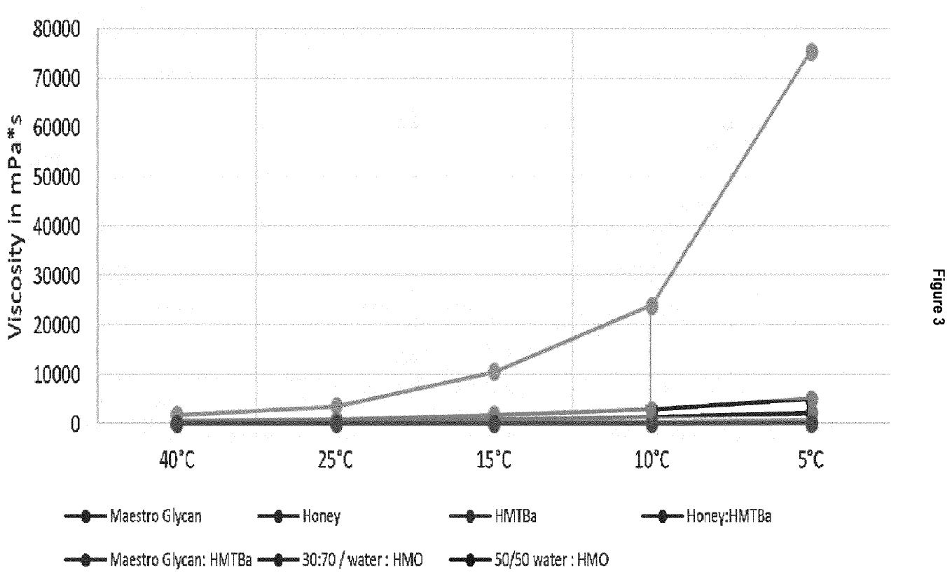

The results of the viscosity measurements of the test systems were shown graphically in FIG. 3Error!Reference source not found. The arrow indicates a decrease in the viscosity of pure compound and its blend.

A strong reduction in the viscosity could be observed particularly well in FIG. 3 when comparing the viscosity of oligosaccharide such as honey before mixing with HMTBA with the one of the corresponding blend. The decrease in the viscosity from this specific case is from 23993 mPa*s to 400 mPa*s.

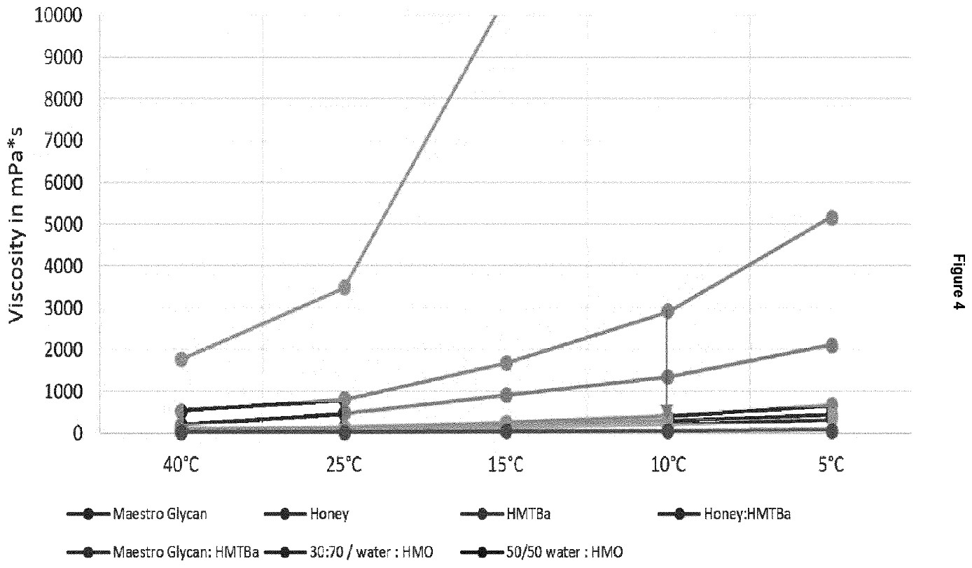

The decrease in the viscosities of other oligosaccharides compared to their corresponding blends can be seen in FIG. 4. The arrow indicates a decrease in viscosity.

Surprisingly, the viscosity of the pure Maestro Glycan shows a decrease of about 10 times (from 2895 mPa*s to 287 mPa*s) when mixed with HMTBA at 10 °C. This effect can also be observed with the mixtures of other oligosaccharides and HMTBA as mentioned above.

In conclusion, the addition of oligosaccharides to a liquid analogue of methionine (HMTBA) as tested here did not show particular changes in the physical appearance and other characteristic parameters such as temperatures indicating the enthalpy of mixing. This points towards a certain physical stability of the blends.

The addition of such oligosaccharides to HMTBA did show a strong change in their viscosity decreasing to a surprisingly low level. The decrease in viscosity is potentially useful in the handling properties of such blends and can be considered for further industrial applications, e.g., for co-application directly in feed.

1. A method for reducing the viscosity of a (liquid) composition comprising a saccharide, said method comprising admixing to a composition comprising said saccharide a viscosity-reducing amount of an amino acid, a functionalized amino acid or an amino acid analogue,
thereby reducing the viscosity of said composition comprising said saccharide and said viscosity-reducing amount of said amino acid when being in liquid state.

2. Use of an amino acid for reducing the viscosity of a (liquid) composition comprising a saccharide.

3. The method or use of claim 1, wherein said composition comprising a saccharide is in liquid state when said viscosity-reducing amount of an amino acid is admixed thereto.

4. The method or use of claim 1, wherein said viscosity-reducing amount of an amino acid admixed to said composition comprising a saccharide is in liquid state.

5. The method or use of claim 1, wherein said composition comprising a saccharide is in liquid state when said viscosity-reducing amount of an amino acid is admixed thereto and said viscosity-reducing amount of an amino acid admixed to said composition comprising a saccharide is in liquid state.

6. The method or use of claim 1, wherein said composition comprising a saccharide is in liquid state when said viscosity-reducing amount of an amino acid is admixed thereto and said viscosity-reducing amount of an amino acid admixed to said composition comprising a saccharide is in solid state.

7. The method or use of claim 1, wherein said composition comprising a saccharide when being in liquid state has a viscosity of at least 250 mPa*s at 25 °C before said viscosity-reducing amount of an amino acid is admixed.

8. The method or use of claim 1, wherein said viscosity-reducing amount of an amino acid is admixed to said composition containing a saccharide such that said amino acid is present in an amount of about 10 times more than the amount of said saccharide, preferably 5 times more, preferably 3.5 times more present, or 1.8 times more.

9. The method or use of claim 1, wherein the amino acid is an amino acid analogue, a naturally-occurring amino acid, an unnatural amino acid or a functionalized amino acid, or a salt thereof.

10. A composition comprising a saccharide and an amino acid, said amino acid being present in said composition in amount such that it reduces the viscosity of said composition when said composition is in liquid state.

11. The composition of claim 10, wherein said amino acid is present is said composition in an amount of about 10 times more than the amount of said saccharide, preferably 5 times more, preferably 3.5 times more present, or 1.8 times more.

12. Animal feed or human food comprising the composition of claim 10.

13. A kit comprising a saccharide and an amino acid, said amino acid being present in said kit in amount such that it reduces the viscosity of said saccharide when being present in a composition in liquid state.

14. A method for feeding an animal comprising providing the composition of claim 10, the animal feed or the kit to an animal.

15. Use of the composition of claim 10, the animal feed, or the kit for feeding an animal.
